(19) United States
(12) Patent Application Publication
(10) Pub. No.: US 2026/0269158 A1
(43) Pub. Date: Sep. 10, 2026

(54) CONTACT ASSEMBLY OF BREAKING DEVICE AND DUAL-POWER TRANSFER SWITCH

(71) Applicant: Schneider Electric Industries SAS, Rueil-Malmaison (FR)

(72) Inventors: Jian Wu, Shanghai (CN); Sha Li, Shanghai (CN); Zhenzhong Liu, Shanghai (CN); Yanming Pan, Shanghai (CN)

(21) Appl. No.: 19/558,919

(22) Filed: Mar. 6, 2026

(30) Foreign Application Priority Data
Mar. 7, 2025 (CN) 202520405491.1

(51) Int. Cl. H01H 33/08

(52) U.S. Cl. CPC H01H 33/08

(57) ABSTRACT

A contact assembly includes: an arc extinguishing assembly including an arc extinguishing grid group located in an arc extinguishing chamber, and first and second arc guide plates located at two ends of the chamber; a fixed contact connected to an inlet terminal, where the fixed contact includes a U-shaped structure including first and second segments opposite to each other, the first segment is pivotally connected to a first pivot shaft, so that the fixed contact is rotatable between a first closed position and a first open position, the second segment is provided with a fixed contact point, and when the fixed contact is in the first open position, a free end of the second segment is close to the first arc guide plate; and a contact pressure member elastically abutting against the fixed contact to apply a force to the fixed contact to move it towards the first open position.

### FIELD

Embodiments of the present disclosure generally relate to the field of electrical equipment, and in particular, to a contact assembly of a breaking device and a dual-power transfer switch.

### BACKGROUND

In some electrical devices, in order to avoid power failure of the electrical devices caused by power supply faults, the electrical devices are usually equipped with two independent power supplies, namely a normal power supply and a standby power supply. The normal power supply and the standby power supply selectively supply power to the electrical devices through a dual-power transfer switch (also referred to as an automatic dual-power transfer switch), thereby providing a continuous power supply for important electrical devices.

The dual-power transfer switch includes two contact assemblies, each contact assembly includes a fixed contact, a movable contact mounted on the movable contact bracket, and an arc extinguishing assembly. The movable contact bracket can rotate between an open position and a closed position. When the movable contact bracket is in the open position, the movable contact on the movable contact bracket is separated from the fixed contact, and at this point, the contact assembly is in an open state. When the movable contact bracket is in the closed position, the movable contact on the movable contact bracket abuts against the fixed contact, and at this point, the contact assembly is in a closed state. When one of the two contact assemblies is in the closed state, the other is in the open state, so that one of the normal power supply and the standby power supply supplies power to the electrical device. The arc extinguishing assembly is used for extinguishing an arc generated when the movable contact is separated from the fixed contact.

### SUMMARY

In a first aspect of the present disclosure, a contact assembly of a breaking device for a dual-power transfer switch is provided. The contact assembly includes: an arc extinguishing assembly including an arc extinguishing grid group located in an arc extinguishing chamber, and a first arc guide plate and a second arc guide plate located at two ends of the arc extinguishing chamber; a fixed contact connected to an inlet terminal through a first braid, where the fixed contact includes a U-shaped structure including a first segment and a second segment opposite to each other, the first segment is pivotally connected to a first pivot shaft, so that the fixed contact is rotatable between a first closed position and a first open position, the second segment is provided with a fixed contact point, and when the fixed contact is in the first open position, a free end of the second segment is close to the first arc guide plate; and a contact pressure member elastically abutting against the fixed contact to apply a force to the fixed contact to move it towards the first open position.

In some embodiments, the contact assembly further includes a shield member disposed between the first segment and the second segment.

In some embodiments, the fixed contact further includes a third segment, the first segment is pivotally connected to the first pivot shaft through the third segment, and the third segment extends obliquely from the first segment towards the first arc guide plate.

In some embodiments, the fixed contact further includes a fourth segment extending from an end of the third segment away from the first segment, and the first pivot shaft is located at a junction between the third segment and the fourth segment, and the first braid is connected to the fourth segment.

In some embodiments, the contact assembly further includes: a movable contact provided with a movable contact point; and a movable contact bracket fixedly connected to the movable contact and connected to a load terminal through a second braid. The movable contact bracket is sleeved on a second pivot shaft, so that the movable contact is rotatable between a second closed position and a second open position, and when the movable contact is in the second closed position, the movable contact point abuts against the fixed contact point to hold the fixed contact in the first closed position.

In some embodiments, the contact assembly further includes gas-generating plates located at two sides of the rotation trajectory of the movable contact.

In some embodiments, the second segment includes a main body portion, the fixed contact point protrudes from a middle portion of the main body portion, and the main body portion is further provided with an arc guide protrusion which extends from a side wall of the fixed contact point to a free end of the main body portion.

In some embodiments, the contact pressure member includes an elastic member abutting against the first segment.

In some embodiments, the contact pressure member further includes: a fixing plate disposed on a housing of the breaking device; and a support member connected to the fixing plate, the elastic member being sleeved on the support member.

In a second aspect of the present disclosure, a dual-power transfer switch is provided. The dual-power transfer switch includes a breaking device including two contact assemblies of the breaking device according to a first aspect of the present disclosure.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an internal structure of a breaking device for a dual-power transfer switch according to embodiments of the present disclosure, and the breaking device includes two contact assemblies according to embodiments of the present disclosure;

FIG. 2 illustrates a schematic perspective view of the breaking device shown in FIG. 1; and

FIGS. 3-6 illustrate the opening process of one of the two contact assemblies in FIG. 1.

### DETAILED DESCRIPTION

Embodiments of the present disclosure will be described in more detail below with reference to the accompanying drawings. While embodiments of the present disclosure are shown in the drawings, it should be understood that the present disclosure may be implemented in various forms and should not be limited by embodiments set forth herein. Rather, these embodiments are provided to make this disclosure more thorough and complete, and to fully convey the scope of the present disclosure to those skilled in the art.

As used herein, the term “including” and variations thereof represent openness, i.e., “including but not limited to”. Unless specifically stated, the term “or” means “and/or”. The term “based on” means “based at least in part on”. The terms “an example embodiment” and “an embodiment” mean “at least one example embodiment”. The term “another embodiment” means “at least one further embodiment”. The terms “first”, “second”, and the like may refer to different or identical objects.

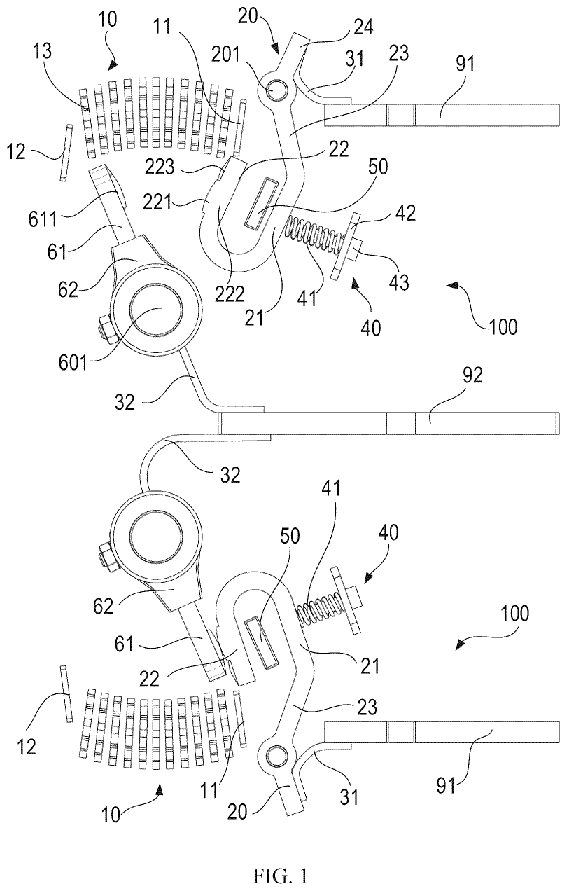

Embodiments of the present disclosure provides a contact assembly of a breaking device and a dual-power transfer switch. The dual-power transfer switch equipped with the contact assembly has good conduction and breaking performance, and also has favorable short-time withstand current performance. Hereinafter, the principles of the present disclosure will be described with reference to FIGS. 1 to 6.

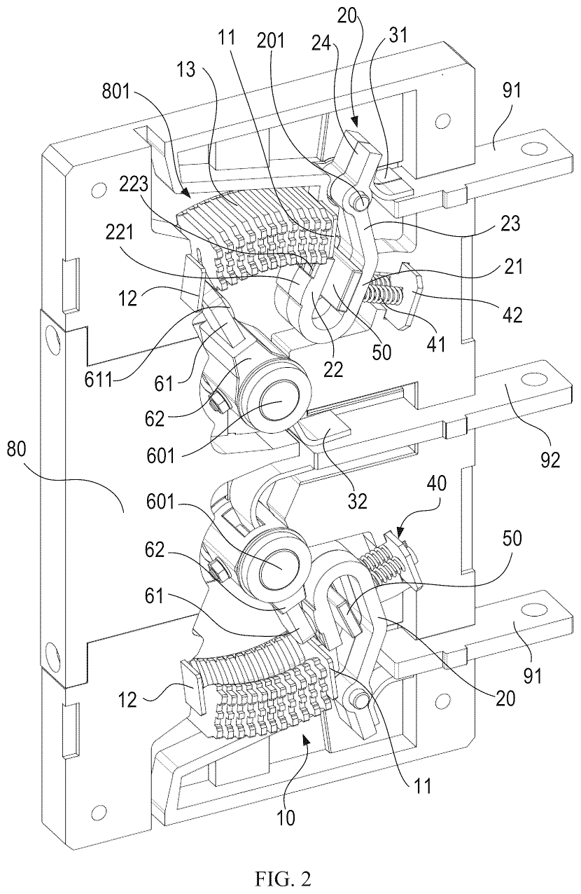

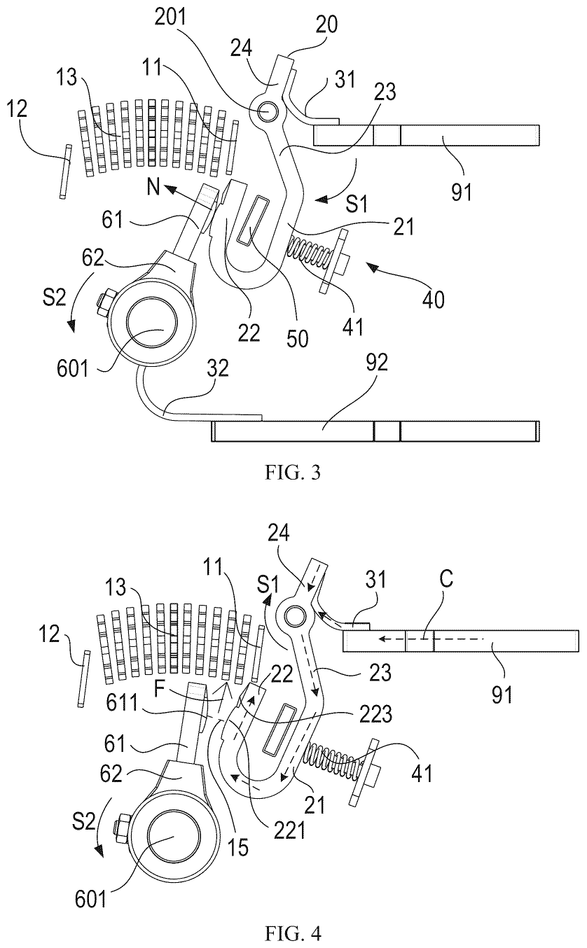

FIG. 1 illustrates a schematic diagram of an internal structure of a breaking device for a dual-power transfer switch according to embodiments of the present disclosure, and the breaking device includes two contact assemblies 100 according to embodiments of the present disclosure. FIG. 2 illustrates a schematic perspective view of the breaking device shown in FIG. 1. FIGS. 3-6 illustrate the opening process of one of the two contact assemblies 100 in FIG. 1.

The breaking device for the dual-power transfer switch according to embodiments of the present disclosure includes a housing 80 and two contact assemblies 100 disposed on the housing 80. The two contact assemblies 100 are substantially identical in structure. The structure of the contact assembly 100 will be described below mainly by taking a contact assembly 100 as an example.

Referring to FIGS. 1 and 2, the contact assembly 100 includes an arc extinguishing assembly 10, a fixed contact 20, a contact pressure member 40, a shield member 50, a movable contact 61, and a movable contact bracket 62.

An arc extinguishing chamber 801 is formed in an inner cavity of the housing 80 of the breaking device, and the arc extinguishing assembly 10 is disposed in the arc extinguishing chamber 801. The arc extinguishing assembly 10 includes an arc extinguishing grid group 13 located in the arc extinguishing chamber 801, and a first arc guide plate 11 and a second arc guide plate 12 located at two ends of the arc extinguishing chamber 801.

An inlet terminal 91 of the breaking device extends into the inner cavity of the housing 80 from the outside of the housing 80, and the inlet terminal 91 is adapted to be connected to a corresponding one of a normal power supply and a standby power supply.

The fixed contact 20 is disposed in the inner cavity of the housing 80, and is located between the first arc guide plate 11 and the inlet terminal 91. The fixed contact 20 is connected to the inlet terminal 91 through a first braid 31. The fixed contact 20 is sleeved on the first pivot shaft 201, so that the fixed contact 20 can rotate about the first pivot shaft 201 between a first closed position and a first open position. An included angle between the first closed position and the first open position is relatively small. Any suitable angular limiting mechanism may be disposed in the housing 80 to limit the rotation range of the fixed contact 20.

In some embodiments, the fixed contact 20 is generally of a bent shape. Specifically, the fixed contact 20 may include a U-shaped structure, a third segment 23, and a fourth segment 24. In some embodiments, the opening of the U-shaped structure faces towards the first pivot shaft 201, and the arc extinguishing assembly 10 is located between the first pivot shaft 201 and the U-shaped structure. The U-shaped structure may include a first segment 21 and a second segment 22 opposite to each other. The second segment 22 is located between the first segment 21 and the movable contact 61, and the second segment 22 is provided with a fixed contact point 221. The third segment 23 extends obliquely from the first segment 21 towards the first arc guide plate 11, and an end of the third segment 23 away from the first segment 21 is pivotally connected to the first pivot shaft 201, such that the first segment 21 is pivotally connected to the first pivot shaft 201 through the third segment 23. The fourth segment 24 extends from an end of the third segment 23 away from the first segment 21, i.e., the first pivot shaft 201 is located at a junction between the third segment 23 and the fourth segment 24. The first braid 31 is connected to the fourth segment 24.

Of course, embodiments of the fixed contact 20 are not limited to examples described above. For example, in some alternative embodiments, the third segment 23 extends in the same direction as the first segment 21. In some alternative embodiments, the fourth segment 24 may be omitted, and the first braid 31 is directly connected to the third segment 23.

The contact pressure member 40 is located in the inner cavity of the housing 80, and the contact pressure member 40 elastically abuts against the fixed contact 20 to apply an elastic force to the fixed contact 20 to move it towards the first open position. In some embodiments, the contact pressure member 40 includes, for example, an elastic member 41, a fixing plate 42, and a support member 43. The fixing plate 42 may be disposed on the housing 80 of the breaking device. The support member 43 may be, for example, a screw, and the support member 43 is connected to the fixing plate 42 by, for example, a threaded connection. The elastic member 41 may be, for example, a spring, and the elastic member 41 is sleeved on the support member 43. The elastic member 41, for example, abuts against the first segment 21 of the fixed contact 20. Of course, embodiments of the contact pressure member 40 are not limited thereto, as long as the contact pressure member 40 can apply the elastic force to the fixed contact 20 to move it towards the first open position.

The movable contact 61 and the movable contact bracket 62 are located in the inner cavity of the housing 80. The movable contact 61 is fixedly connected to the movable contact bracket 62, and the movable contact 61 is provided with a movable contact point 611. The movable contact bracket 62 is connected to a load terminal 92 through a second braid 32, and the load terminal is connected to the electrical device.

It should be noted that, in some embodiments, the movable contact brackets 62 of the two contact assemblies 100 are connected to the same load terminal 92 through corresponding second braids 32. In some alternative embodiments, the movable contact brackets 62 of the two contact assemblies 100 are respectively connected to two load terminals 92 through corresponding second braids 32, and the two load terminals 92 may be stacked together and electrically connected to each other.

The movable contact bracket 62 is sleeved on the second pivot shaft 601, so that the movable contact 61 can rotate between a second closed position and a second open position. The movable contact 61 may be held in the second closed position or the second open position by an operating mechanism (not shown) connected to the movable contact bracket 62.

In the two contact assemblies 100 shown in FIG. 1, the upper contact assembly 100 is in an open state, and the lower contact assembly 100 is in a closed state. In the upper contact assembly 100, the movable contact 61 is in the second open position, the fixed contact 20 is held in the first open position under the pressure of the contact pressure member 40, the movable contact 61 and the fixed contact 20 are away from each other, and the inlet terminal 91 is disconnected from the load terminal 92. In the lower contact assembly 100, the movable contact 61 is in the second closed position, the fixed contact 20 is pressed by the movable contact 61 to the first closed position, the elastic member 41 is compressed, the movable contact point 611 of the movable contact 61 abuts against the fixed contact point 221 of the fixed contact 20, and an electrical path is formed between the inlet terminal 91 and the load terminal 92.

In embodiments according to the present disclosure, when the movable contact is separated from the fixed contact, the fixed contact may rotate about the first pivot shaft to the first open position. At the first open position, the free end of the second segment of the fixed contact is close to the first arc guide plate, and the current flowing in the second segment generates a magnetic field surrounding the second segment. The magnetic field exerts a magnetic blow force on the arc between the fixed contact and the movable contact to move the arc into the arc extinguishing chamber, thereby facilitating the rapid extinction of the arc and improving the conduction and breaking performance of the contact assembly.

The opening process of the contact assembly 100 will be described below with reference to FIGS. 3 to 6 by taking one of the two contact assemblies 100 as an example. To simplify the views, the second braid 32 and the load terminal 92 are not shown in FIGS. 4 to 6.

Referring to FIG. 3, the contact assembly 100 is in the closed state, and the movable contact 61 is held in the second closed position by the operating mechanism connected to the movable contact bracket 62. The fixed contact 20 is held in the first closed position by the abutment between the movable contact point 611 and the fixed contact point 221. The free end of the second segment 22 of the fixed contact 20 is offset from the first arc guide plate 11. The elastic member 41 of the contact pressure member 40 is compressed. Current from the normal power supply or the standby power supply flows into the electrical device connected to the load terminal 92 through the inlet terminal 91, the first braid 31, the fixed contact 20, the movable contact 61, the second braid 32, and the load terminal 92 in sequence.

Both the fixed contact 20 and the movable contact 61 are subjected to an electrodynamic force in a direction indicated by arrow N in FIG. 3. When an overcurrent occurs in the circuit, although the electrodynamic force increases, the movable contact 61 fixed on the movable contact bracket 62 can be held in the second closed position under the action of the operating mechanism, rather than immediately rotating about the second pivot shaft 601 in a direction S2. Meanwhile, under the action of the contact pressure member 40 and the electrodynamic force, the fixed contact 20 tends to rotate about the first pivot shaft 201 in a direction S1, so that the fixed contact point 221 of the fixed contact 20 and the movable contact point 611 of the movable contact 61 are in close contact, thereby maintaining the contact assembly 100 in the closed state. Therefore, the contact assembly 100 has a relatively high short-time withstand current performance. In this way, even if an overcurrent occurs due to circuit failure, the dual-power transfer switch can still effectively carry current. After the faulty circuit is disconnected by a corresponding circuit breaker, the dual-power transfer switch can effectively switch the power supply. Since the contact assembly 100 has a relatively high short-time withstand current performance, on the one hand, the contact assembly 100 can be prevented from being damaged due to overcurrent, and on the other hand, the available time of the continuous power supply can be effectively improved.

Referring to FIG. 4, during power supply switching, the operating mechanism controls the movable contact 61 to rotate about the second pivot shaft 601 in the direction S2 through the movable contact bracket 62. The fixed contact 20 rotates about the first pivot shaft 201 in the direction S1 to the first open position under the urging of the contact pressure member 40. The fixed contact 20 in FIG. 4 is in the first open position. When the fixed contact 20 moves to the first open position, the fixed contact 20 no longer continues to rotate in the direction S1, and the movable contact point 611 of the movable contact 61 starts to be separated from the fixed contact point 221 of the fixed contact 20.

When the fixed contact 20 is in the first open position, the free end of the second segment 22 of the fixed contact 20 is close to the first arc guide plate 11, and a gap between the first arc guide plate 11 and the free end of the second segment 22 is relatively small.

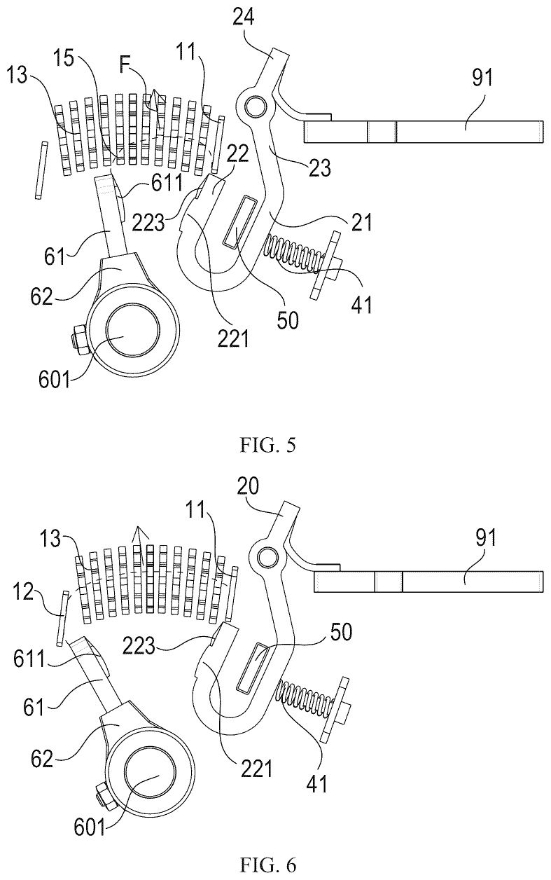

Referring to FIGS. 4 and 5, after the movable contact point 611 of the movable contact 61 is separated from the fixed contact point 221 of the fixed contact 20, an arc 15 is generated between the movable contact 61 and the fixed contact 20. When the movable contact 61 rotates in the direction S2, the arc 15 moves from the fixed contact 20 towards the first arc guide plate 11. The current flowing from the inlet terminal 91 and indicated by dashed arrow C flows towards the second segment 22, and the current flowing through the second segment 22 generates a magnetic field surrounding the second segment 22. The magnetic field exerts a magnetic blow force indicated by arrow F on the arc 15, so that the arc 15 can quickly enter the arc extinguishing chamber 801 to be extinguished. Thereby, the conduction and breaking performance and the electrical operating performance of the contact assembly 100 are improved.

With reference to FIGS. 1, 2 and 5, in some embodiments, the second segment 22 includes a main body portion 222, and the free end of the second segment 22 corresponds to a free end of the main body portion 222. The fixed contact point 221 protrudes from a middle portion of the main body portion 222. The main body portion 222 is further provided with an arc guide protrusion 223 which extends from a side wall of the fixed contact point 221 to the free end of the main body portion 222. When the fixed contact 20 is in the first open position, a surface of the first arc guide plate 11 on the side facing towards the arc extinguishing grid group 13 is close to a surface of the arc guide protrusion 223, which facilitates the arc to move from the fixed contact point 221 of the fixed contact 20 to the first arc guide plate 11 through the arc guide protrusion 223, thereby preventing the fixed contact point 221 from being excessively ablated by the arc.

In some embodiments, the contact assembly 100 may further include a shield member 50 disposed between the first segment 21 and the second segment 22. The shield member 50 is configured to shield the magnetic field generated by the current flowing through the first segment 21, so as to prevent the magnetic field generated by the current flowing through the first segment 21 from adversely affecting the movement of the arc 15 to the arc extinguishing chamber 801.

Referring to FIG. 6, the movable contact 61 rotates to the second open position and is held in the second open position by the operating mechanism connected to the movable contact bracket 62. At this point, the movable contact 61 is close to the second arc guide plate 12, and the arc 15 can move towards the arc extinguishing chamber 801 through the second arc guide plate 12 to be split by the arc extinguishing grid group 13.

In some embodiments, the contact assembly 100 may further include gas-generating plates (not shown) located at two sides of the rotation trajectory of the movable contact 61. When the movable contact 61 is separated from the fixed contact 20, the gas-generating plates are ablated by the arc 15 and generate a large amount of gas, which causes the pressure inside the arc extinguishing chamber 801 to rise and form a pressure difference between the inside and the outside of the arc extinguishing chamber 801. The gas flows from the arc extinguishing chamber 801 to the outside of the arc extinguishing chamber 801 to form a gas-blowing effect on the arc 15, which further helps the arc 15 to quickly enter the arc extinguishing chamber 801 to be extinguished. In this way, the conduction and breaking performance of the contact assembly 100 can be further improved.

Embodiments of the present disclosure further provides a dual-power transfer switch including a breaking device which includes two contact assemblies 100 according to embodiments of the present disclosure.

In the contact assembly 100 according to embodiments of the present disclosure, when the movable contact 61 is separated from the fixed contact 20, the fixed contact 20 may rotate about the first pivot shaft 201 to the first open position. At the first open position, the free end of the second segment 22 of the fixed contact 20 is close to the first arc guide plate 11, and the current flowing through the second segment 22 generates a magnetic field surrounding the second segment 22. The magnetic field exerts a magnetic blow force on the arc 15 between the fixed contact 20 and the movable contact 61 to move the arc 15 into the arc extinguishing chamber 801, thereby facilitating the rapid extinction of the arc 15 and improving the conduction and breaking performance of the contact assembly 100.

In addition, the movable contact 61 is fixed to the movable contact bracket 62, and when the movable contact point 611 of the movable contact 61 abuts against the fixed contact point 221 of the fixed contact 20, the movable contact 61 may be held in the first closed position by the operating mechanism connected to the movable contact bracket 62. In this way, when an overcurrent occurs in the circuit, the movable contact point 611 of the movable contact 61 and the fixed contact point 221 of the fixed contact 20 abut against each other instead of being immediately separated from each other, thereby enabling the contact assembly 100 to have a relatively high short-time withstand current performance.

It can be understood that the dual-power transfer switch employing the contact assembly 100 has good electrical operating performance, conduction and breaking performance, and short-time withstand current performance.

Various embodiments of the present disclosure have been described above, which are illustrative, not exhaustive, and are not limited to embodiments disclosed. Many modifications and variations will be apparent to those of ordinary skill in the art without departing from the scope and spirit of the illustrated embodiments. The selection of the terms used herein is intended to explain the principles of the embodiments, practical applications, or technical improvements in the marketplace, or to enable others of ordinary skill in the art to understand the embodiments disclosed herein.

1. A contact assembly of a breaking device for a dual-power transfer switch, comprising:
an arc extinguishing assembly comprising an arc extinguishing grid group located in an arc extinguishing chamber, and a first arc guide plate and a second arc guide plate located at two ends of the arc extinguishing chamber;
a fixed contact connected to an inlet terminal through a first braid, wherein the fixed contact comprises a U-shaped structure comprising a first segment and a second segment opposite to each other, the first segment is pivotally connected to a first pivot shaft, so that the fixed contact is rotatable between a first closed position and a first open position, the second segment is provided with a fixed contact point, and when the fixed contact is in the first open position, a free end of the second segment is close to the first arc guide plate; and
a contact pressure member elastically abutting against the fixed contact to apply a force to the fixed contact to move it towards the first open position.

2. The contact assembly of claim 1, further comprising a shield member disposed between the first segment and the second segment.

3. The contact assembly of claim 1, wherein the fixed contact further comprises a third segment, the first segment is pivotally connected to the first pivot shaft through the third segment, and the third segment extends obliquely from the first segment towards the first arc guide plate.

4. The contact assembly of claim 3, wherein
the fixed contact further includes a fourth segment extending from an end of the third segment away from the first segment, and
the first pivot shaft is located at a junction between the third segment and the fourth segment, and the first braid is connected to the fourth segment.

5. The contact assembly of claim 1, further comprising:
a movable contact provided with a movable contact point; and
a movable contact bracket fixedly connected to the movable contact and connected to a load terminal through a second braid, and
wherein the movable contact bracket is sleeved on a second pivot shaft, so that the movable contact is rotatable between a second closed position and a second open position, and when the movable contact is in the second closed position, the movable contact point abuts against the fixed contact point to hold the fixed contact in the first closed position.

6. The contact assembly of claim 5, further comprising gas-generating plates located at two sides of the rotation trajectory of the movable contact.

7. The contact assembly of claim 1, wherein
the second segment comprises a main body portion, the fixed contact point protrudes from a middle portion of the main body portion, and
the main body portion is further provided with an arc guide protrusion which extends from a side wall of the fixed contact point to a free end of the main body portion.

8. The contact assembly of claim 1, wherein the contact pressure member comprises an elastic member abutting against the first segment.

9. The contact assembly of claim 8, wherein the contact pressure member further comprises:
a fixing plate disposed on a housing of the breaking device; and
a support member connected to the fixing plate, the elastic member being sleeved on the support member.

10. A dual-power transfer switch, comprising a breaking device comprising two contact assemblies, wherein each contact assembly comprises:
an arc extinguishing assembly comprising an arc extinguishing grid group located in an arc extinguishing chamber, and a first arc guide plate and a second arc guide plate located at two ends of the arc extinguishing chamber;
a fixed contact connected to an inlet terminal through a first braid, wherein the fixed contact comprises a U-shaped structure comprising a first segment and a second segment opposite to each other, the first segment is pivotally connected to a first pivot shaft, so that the fixed contact is rotatable between a first closed position and a first open position, the second segment is provided with a fixed contact point, and when the fixed contact is in the first open position, a free end of the second segment is close to the first arc guide plate; and
a contact pressure member elastically abutting against the fixed contact to apply a force to the fixed contact to move it towards the first open position.

11. The dual-power transfer switch of claim 10, further comprising a shield member disposed between the first segment and the second segment.

12. The dual-power transfer switch of claim 10, wherein the fixed contact further comprises a third segment, the first segment is pivotally connected to the first pivot shaft through the third segment, and the third segment extends obliquely from the first segment towards the first arc guide plate.

13. The dual-power transfer switch of claim 12, wherein
the fixed contact further includes a fourth segment extending from an end of the third segment away from the first segment, and
the first pivot shaft is located at a junction between the third segment and the fourth segment, and the first braid is connected to the fourth segment.

14. The dual-power transfer switch of claim 10, further comprising:
a movable contact provided with a movable contact point; and
a movable contact bracket fixedly connected to the movable contact and connected to a load terminal through a second braid, and
wherein the movable contact bracket is sleeved on a second pivot shaft, so that the movable contact is rotatable between a second closed position and a second open position, and when the movable contact is in the second closed position, the movable contact point abuts against the fixed contact point to hold the fixed contact in the first closed position.

15. The dual-power transfer switch of claim 14, further comprising gas-generating plates located at two sides of the rotation trajectory of the movable contact.

16. The dual-power transfer switch of claim 10, wherein
the second segment comprises a main body portion, the fixed contact point protrudes from a middle portion of the main body portion, and
the main body portion is further provided with an arc guide protrusion which extends from a side wall of the fixed contact point to a free end of the main body portion.

17. The dual-power transfer switch of claim 10, wherein the contact pressure member comprises an elastic member abutting against the first segment.

18. The dual-power transfer switch of claim 17, wherein the contact pressure member further comprises:
a fixing plate disposed on a housing of the breaking device; and
a support member connected to the fixing plate, the elastic member being sleeved on the support member.
